(19) United States
(12) Patent Application Publication
(10) Pub. No.: US 2007/0001437 A1
(43) Pub. Date: Jan. 4, 2007

(54) Single stage inflator

(75) Inventors: Andrew P. Wall, Lakeland, FL (US); Edward O. Hosey, Lakeland, FL (US); Anthony J. Curtis, Palm Harbor, FL (US); Michael E. Kelley, Valrico, FL (US); John H. Adams, Lakeland, FL (US)

Correspondence Address: KEY SAFETY SYSTEMS, INC.;PATENT DEPARTMENT, 5300 ALLEN K BREED HIGHWAY, LAKELAND, FL, 33811-1130, US

(73) Assignee: Key Safety Systems, Inc.

(21) Appl. No.: 11/171,688

(22) Filed: Jul. 1, 2005

(51) Int. Cl. B60R 21/26

(52) U.S. Cl. 280/736; 280/741

(57) ABSTRACT

The present invention described hereafter provides a single stage inflator with a disk shaped inflator housing with one initiator having a single initiating squib located in an initiator housing, the initiator housing being offset relative to the centerline of the disk shaped inflator housing.

### FIELD OF THE INVENTION

The present invention relates to airbag inflators, more specifically a single stage driver side inflator.

### BACKGROUND OF THE INVENTION

The deployment of an airbag module requires a device for rapid, controlled release of a gaseous fluid. This device is commonly referred to as an inflator.

The inflator uses a gas generant that when ignited rapidly generates a large but controlled release of hot gases to fill the airbag.

As shown in FIG. 1, a typical single stage inflator has an initiator that is most typically a squib type device encased in an initiator housing filled with a booster charge. When the squib is activated it ignites an enhancer charge in the initiator housing and that charge generates hot particles and gases, which ignite the gas generant within the disk shaped housing. This prior art device is centrally and symmetrically charged. The initiator is centered in the centerline of the housing and accordingly the generant surrounds the initiator housing and therefore can be easily ignited uniformly and thus burns radially outwardly with a neutral or almost neutral thrust. One such device is found in U.S. Pat. No. 6,796,579 B1. As shown, the prior art device is commonly referred to as a single stage inflator.

More commonly used, but quite a bit more complex is a dual stage inflator. The dual stage inflators require two initiators and separate enhancer and gas generant chambers. The squibs can be fired one first then the second after a delay or may only fire one squib not firing the second squib at all or both squibs can be fired simultaneously. One such device can be found in U.S. Pat. No. 6,648,370 B1.

Dual stage inflators are obviously more complex and costlier than a single stage inflator. The dual stage inflator also requires typically more enhancer charge to permit the deployment sequence to perform adequately in a sequential fashion with sufficient dwell time during deployment. Single stage inflators are far simpler in design based on fewer components and a simpler firing initiation. Dual stage inflators offer a variable range of protection to passengers, which a single stage inflator cannot provide. Therefore, the use of single stage inflators is far from simple in design complexity when factored into the various requirements of passenger protection. For this reason the use of single stage inflators has been decreasing in spite of the benefits of cost, reliability and simplicity.

In a related, but somewhat ignored consideration is the fact that assembly lines building dual stage inflators are not readily compatible with automated tooling and fixtures used in building single stage inflators. As a result a large investment in capital must be laid out for two separate building lines, one for a single stage inflator and a separate line for a dual stage inflator.

### SUMMARY OF THE INVENTION

The present invention described hereafter provides a single stage inflator with one initiator having a single initiating squib located in an initiator housing, the initiator housing being offset relative to the centerline of the disk shaped inflator housing.

The design can be made compatible with an automated dual stage inflator building line, greatly reducing the required capital cost needed for a second redundant assembly line.

### BRIEF DESCRIPTION OF THE DRAWINGS

FIG. 1 is a bottom plan view of a prior art single stage disk shaped inflator.

FIG. 2 is a cross sectional view of the prior art inflator of FIG. 1 taken along lines 2-2.

FIG. 3 is a bottom plan view of the single stage inflator according to the present invention.

FIG. 4 is a cross sectional view of the inflator of FIG. 3 according to the present invention taken along lines 4-4.

FIG. 5 is a first chart of Pressure KPa versus Time in milliseconds of a first generant charge.

FIG. 6 is a second chart of Pressure KPa versus Time in milliseconds of a second generant charge.

### DETAILED DESCRIPTION OF THE INVENTION

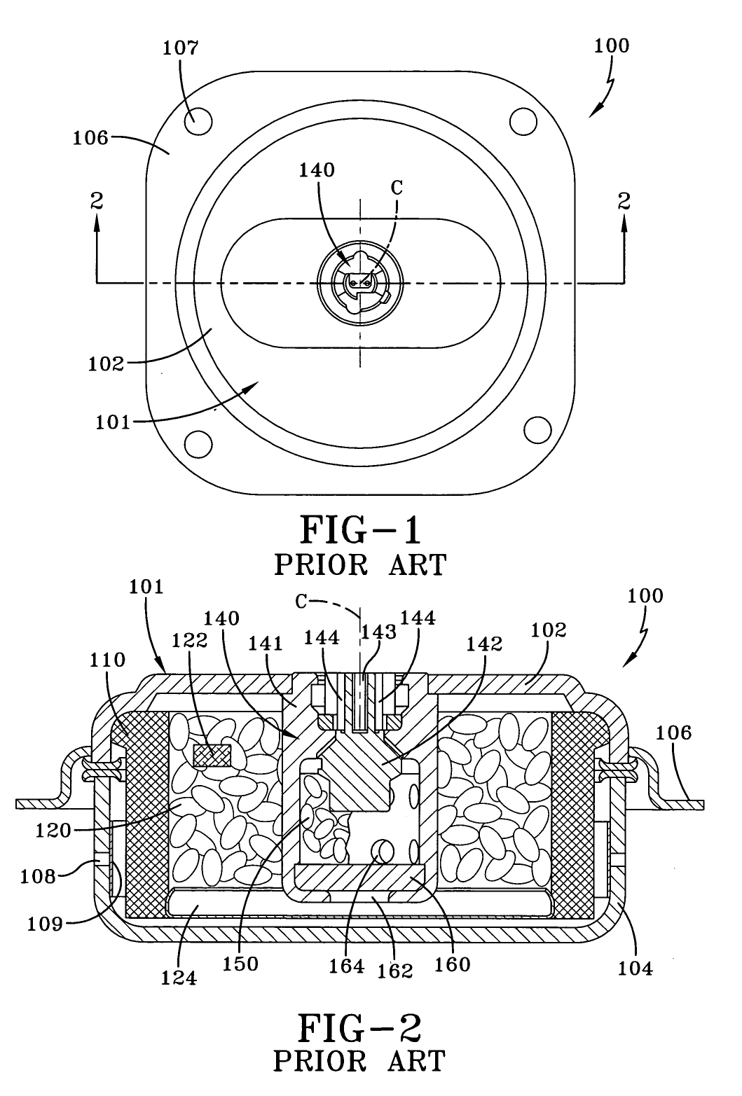

With reference to FIGS. 1 and 2, a prior art single stage disk shaped inflator 100 having a single centrally located initiator housing assembly 140 is illustrated. The inflator 100 as shown has a housing 101 having a top half portion 104 and a bottom half portion 102 welded or otherwise joined together. Encircling the two portions 102, 104 is a mounting flange 106 having a plurality of mounting holes 107 for attaching the inflator 100. As shown, these disk shaped inflators 100 are commonly attached to an airbag module (not Illustrated) for location in the driver side steering wheel.

On the top portion 104 of the housing 101 is shown a plurality of gas vent holes 108 covered or sealed by a foil type burst tape. A cylindrically shaped annular filter 110 of wire mesh or similar material is shown extending from the top portion 104 to the bottom portion 102. The filter 110 blocks burning particles from passing through the vent opening 108 when the inflator gas generant is ignited. A seal 124 is positioned internal to the annular filter 110 upon which gas generant pellets 120 are located along with auto ignition pellet 122. In a central location of the bottom half portion 102 is an initiator housing assembly 140. The initiator housing assembly 140 has a single initiating squib 142 with projecting electrical connectors 143, 144 adapted to connect to a wiring connector (not illustrated). The initiating squib 142 has an explosive charge encapsulated in one end surrounded by an enhancer charge 150 comprising small pellets 152. When activated the initiating squib 142 ignites causing the enhancer charge 150 to ignite which in turn causes a pressure rise internal to the initiator housing 141 forcing hot particles and expanding gases through small openings 164 thereby igniting the generant pellets 120 and auto ignition pellet 122. This creates a further rise in pressure causing the foil 109 to burst and gases to fill the airbag (not shown) upon deployment. The initiator housing 141 has an opening 162 sealed by an end plate 160. Although the auto ignition pellet is not needed for a normal deployment, it is consumed during deployment. In the event that the inflator is heated by an outside source, the auto ignition pellet will begin to burn at a predetermined level, causing the inflator to deploy without structural failure.

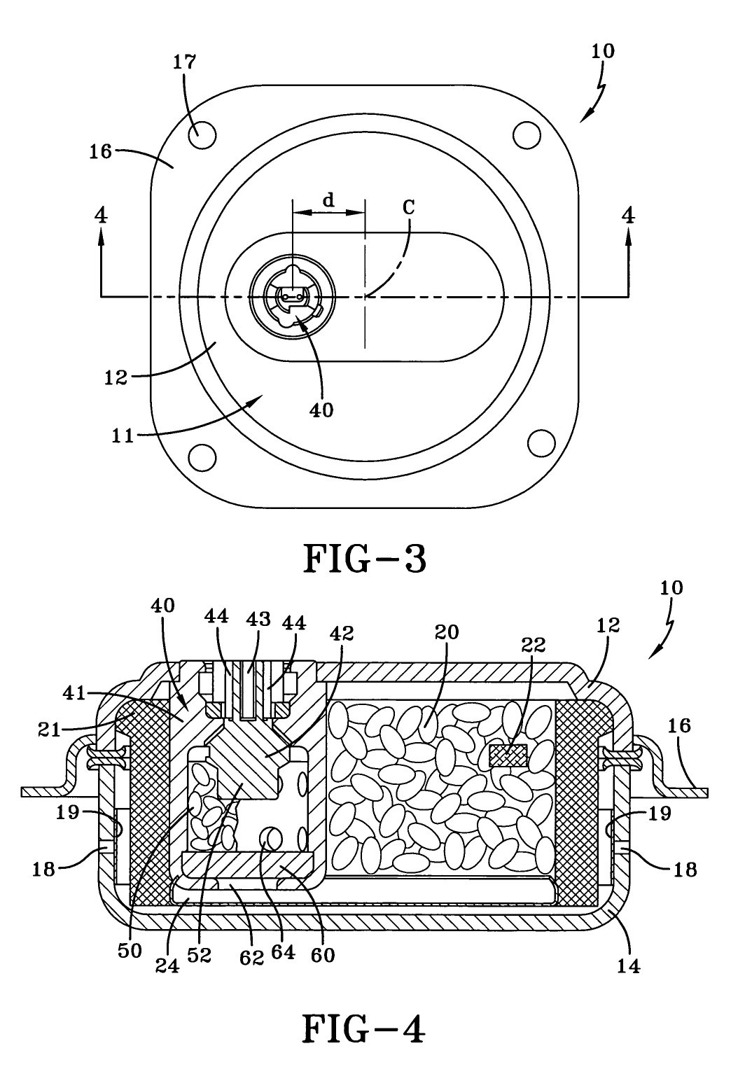

With reference to FIGS. 3 and 4, a prior art single stage disk shaped inflator 10 according to the present invention having a single offset located initiator is illustrated. The inflator 10 as shown has a housing 11 having a top half portion 14 and a bottom half portion 12 welded or otherwise joined together. Encircling the two portions 12,14 is a mounting flange 16 having a plurality of mounting holes 17 for attaching the inflator 10. As shown, this disk shaped inflator 10 is also preferably attached to an airbag module (not illustrated) for location in the driver side steering wheel.

On the top portion 14 of the housing 11 is shown a plurality of gas vent holes 18 covered or sealed by a foil type burst tape 19. A cylindrically shaped annular filter 21 of wire mesh or similar material is shown extending from the top portion 14 to the bottom portion 12. The filter 21 blocks burning particles from passing through the vent opening 18 when the inflator gas generant is ignited. A seal 24 is positioned internal to the annular filter 21 upon which gas generant pellets 20 are located along with auto ignition pellet 22. In an offset location of the bottom half portion 12 is an initiator housing assembly 40. The initiator housing assembly 40 has an initiator housing 41 with a single initiator squib 42 with projecting electrical connectors 43, 44 adapted to connect to a wiring connector (not illustrated). The initiator squib 42 has an explosive charge encapsulated in one end surrounded by an enhancer charge 50 comprising small pellets. When activated the initiator squib 42 ignites causing the enhancer charge 50 inside the initiator housing 41 to ignite which in turn causes a pressure rise internal to the initiator housing 41 forcing hot particles and expanding gases through the small openings 64 in the initiator housing 41 thereby igniting the generant pellets 20 and auto ignition pellet 22. This creates a further rise in pressure causing the foil 19 to burst and gases to fill the airbag (not shown) upon deployment in a single stage fashion. The housing 41 has an end opening 62 sealed by an end plate 60. Although the auto ignition pellet is not needed for a normal deployment, it is consumed during deployment. In the event that the inflator is heated by an outside source, the auto ignition pellet will begin to burn at a predetermined level, causing the inflator to deploy without structural failure.

Referring to FIG. 3, an inflator 10 was constructed of steel. The generant pellets 20 are preferably made of a non-azide gas generant. Representative gas generant compositions useful in the inventive inflator housing include fuels such as aminotetrazoles, tetrazoles, bitetrazoles, triazoles, the metal salts thereof, guanidine nitrate, nitroguanidine, aminoguanidine nitrate and mixtures thereof; in combination with an oxidizer such as the alkali and alkaline earth or transition metal nitrates, chlorates, perchlorates, ammonium nitrate and mixtures thereof. A preferred gas generant comprises a mixture of nitroguanidine with strontium and potassium nitrates. Typically, the gas generant or gas producing material can comprise about 15 to about 70 weight % fuel, about 2 to about 80 weight % oxidizer and about 1 to about 30 weight % other materials, such as coolants, catalysts, binding agents and processing aids. The gas generant can be formed into various shapes using various techniques known to those skilled in the art.

It is desirable to pelletize the gas generant composition. To do so, up to about 5.0 weight %, typically 0.2-5 weight % of a pressing aid or binder may be employed. These may be selected from materials known to be useful for this purpose and include molybdenum disulfide, graphite, elastomers, polyesters, boron nitride, silicon dioxide, talc, calcium stearate and clays.

The gas generant composition may optionally contain a catalyst at up to about 3 weight %, typically between about 1 and about 2 weight %. Cupric oxide is a representative combustion catalyst.

The initiator housing 41 has the plurality of vent holes or openings 64 oriented to direct exhaust into the gas generant pellets 20 with a strong but directional thrust. The openings 64 are located less than 270 degrees, preferably less than 180 degrees around the periphery of the initiator housing 41 in the direction of the gas generant pellets 20 as shown. To compensate for this strong directional thrust effect, the holes 18 on the inflator housing top portion 14 are radially oriented about 360° in a spaced pattern and as these gases move radially outwardly the overall thrust becomes almost thrust neutral with an almost immeasurable thrust bias opposite the initiator housing 41.

With reference to FIG. 3, the offset single stage disk shaped inflator 10 is shown having the initiator housing assembly 40 spaced a distance (d) from a center location (C) of the inflator. The offset displacement is quite unique in that it shifts the initiating squib 42 from a central firing position to one very close to the annular filter 21. Accordingly the openings 64 are also offset meaning the hot particles and gases spraying through the inflator 10 are directionally oriented. The openings 64 preferably are directed on the portions of the initiator housing 41 exposed to the gas generant pellets 20 and the auto ignition pellet 22. In this way the openings 64 of the initiator housing 41 orient the hot particles and gases to facilitate burning of the gas generant pellets 20.

In testing of the inventive inflator 10, it was determined that the enhancer charge should be increased to about 2.0 grams, and the initiating squib charge to be in the range of 180 to 260 mg of zirconium potassium perchlorate (ZPP) for proper performance in terms of airbag deployment. Initiator booster charges in excess of 260 mg were not necessary and in fact could potentially damage the initiator housing by exceeding rated burst pressures of the crimp. Lower amounts of charge, below 180 mg, could cause a delay in the gas generant burning and lead to unsatisfactory airbag deployment pressure or fill rates.

Empirical studies show that the size of the pellets of the enhancer could be beneficially altered to increase or improve surface area for rapid burn rates, accordingly, a pellet having a 4 mm diameter and a 1.2 mm length was found to be ideal from a pressure versus time analysis.

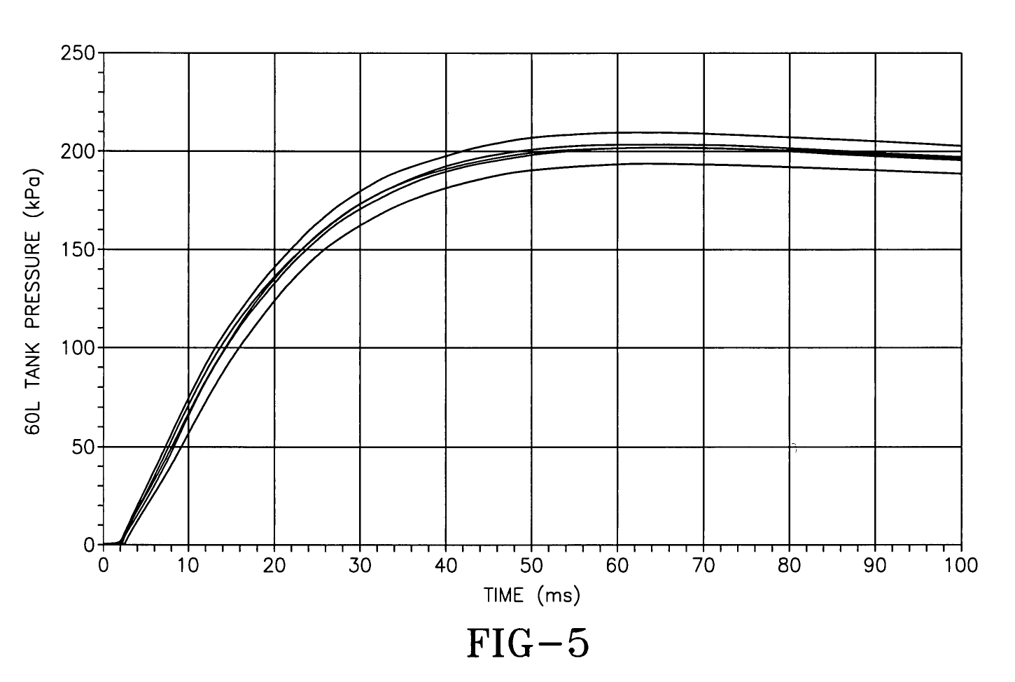

In FIG. 5 a chart is illustrated showing an inflator 10 having a 260 mg initiator booster charge 52, 1.80 g of enhancer pellets 50, 33.5 g of gas generant pellets 20 of a size 8.0 mm diameter by 1.7 mm length. Each line represents a separate test of an inflator 10.

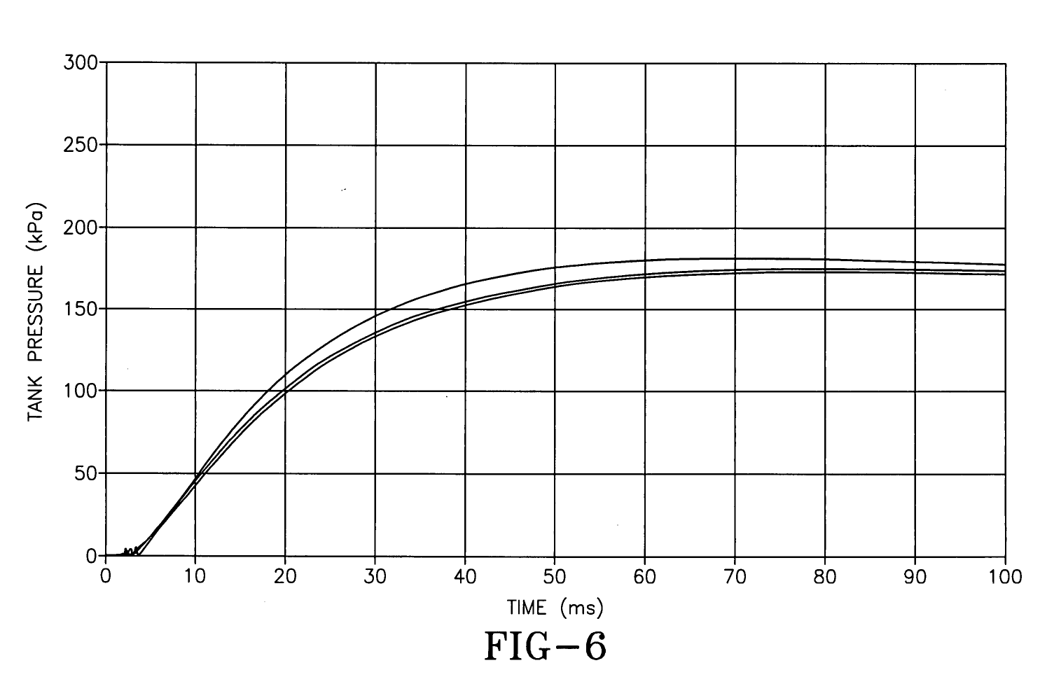

In FIG. 6 a chart is illustrated showing the same proportions by weight, but wherein the 33.5 g of gas generant pellets 20 are of a size 8.0 mm diameter by 2.0 mm length.

As a result of these empirical charts it was projected that a more preferred gas generant pellet 20 size for the offset inflator 10 was a size of 8.0 mm diameter by 2.0 mm length.

For comparison purposes, the dual stage inflator with two initiators uses 180 mg of initiator booster charge and the enhancer charge is 1.1 grams in the primary initiator housing and 1.3 grams in the secondary initiator housing. The present invention uses 180 to 260 mg of initiator booster charge and 2.0 grams of enhancer. This represents a 0.4 gram reduction in the enhancer. The enhancer pellets 50 are more expensive and burn with more toxicity than the generant pellets 20, accordingly, the reduction in enhancer load is believed to be a valuable improvement.

Another benefit of the single stage offset design is it has 20% more free volume than the dual stage inflator. This means the height of the inflator housing could be reduced by at least 10% if further miniaturization is desirable.

The current invention uses an internal spacer of aluminum to occupy the free volume space and thus the housing upper and lower portions are almost identical to the dual stage housing permitting either style to be used on the same production line.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which would be within the full intended scope of the invention as defined by the following appended claims.

1. A single stage airbag inflator comprising:
a disk shaped housing;
a gas generant and an enhancer internal to said disk shaped housing; and
a single initiator, the single initiator having an initiator housing being located offset from a center of the disk shaped housing.

2. The single stage airbag inflator of claim 1 further comprising: an auto ignition pellet internal to the disk shaped housing.

3. The single stage airbag inflator of claim 1 further comprising an annular cylindrical filter adjacent or in close proximity to annular sidewalls of the disk shaped housing.

4. The single stage airbag inflator of claim 3 wherein the single initiator is located offset to the center of the disk shaped housing and adjacent or in close proximity to an inside circumferential portion of the annular cylindrical filter.

5. The single stage airbag inflator of claim 3 further comprising a spacer filler adjacent one end of said disk shaped housing and inside said filter, said spacer filler having an opening or slot for the initiator housing to pass through.

6. The single stage airbag inflator of claim 5 wherein the single initiator is a squib and the initiator housing contains the squib and the enhancer.

7. The single stage airbag inflator of claim 6 wherein the initiator housing has a plurality of vent hole or openings oriented to direct igniter and enhancer exhaust away from the filter and into the gas generant.

8. The single stage airbag inflator of claim 1 wherein the enhancer weighs about 2.0 grams or less.

9. The single stage airbag inflator of claim 8 wherein the enhancer is in pellet form having a size of about 4 mm in diameter by about 1.2 mm in length.

10. The single stage airbag inflator of claim 1 wherein the gas generant is in pellet form having a size of about 8.0 mm in diameter by about 2.0 mm in length.

11. A single stage airbag inflator comprising:
a disk shaped housing;
a gas generant and an enhancer disposed inside of the disk shaped housing; and
a single initiator housing assembly comprising a single initiator disposed in an initiator housing, the single initiator housing assembly being spaced a distance from a center location of the disk shaped housing.

12. A single stage airbag inflator according to claim 1 further comprising an annular filter located inside of the disk shaped housing adjacent or in close proximity to an annular sidewall of the disk shaped housing.

13. A single stage airbag inflator according to claim 2 wherein the single initiator is located adjacent or in close proximity to an inside circumferential portion of the annular filter.

14. A single stage airbag inflator according to claim 13 wherein the initiator housing has a plurality of vent hole or openings oriented to direct gasses from the burning of the initiator and enhancer away from the annular filter and into the gas generant.

15. A single stage airbag inflator according to claim 11 wherein the enhancer weighs about 2.0 g or less and is in the form of a pellet having a size of about 4 mm in diameter by about 1.2 mm in length.

16. A single stage airbag inflator according to claim 11 wherein the gas generant is in the form of a pellet having a size of about 8.0 mm in diameter by about 2.0 mm in length.

17. A single stage airbag inflator comprising:
a disk shaped housing;
a gas generant and an enhancer disposed inside of the disk shaped housing;
an annular filter located inside of the disk shaped housing adjacent or in close proximity to an annular sidewall of the disk shaped housing and between the gas generant and the disk shaped housing; and
a single initiator housing assembly comprising a single initiator and the enhancer disposed in an initiator housing, the single initiator housing assembly being spaced a distance from a center location of the disk shaped housing, the single initiator being located adjacent or in close proximity to an inside circumferential portion of the annular filter, the initiator housing has a plurality of vent hole or openings oriented to direct gasses from the burning of the initiator and enhancer away from the annular filter and into the gas generant.

18. A single stage airbag inflator according to claim 17 wherein the enhancer weighs about 2.0 g or less and is in the form of a pellet having a size of about 4 mm in diameter by about 1.2 mm in length.

19. A single stage airbag inflator according to claim 17 wherein the gas generant is in the form of a pellet having a size of about 8.0 mm in diameter by about 2.0 mm in length.

20. A single stage airbag inflator according to claim 18 wherein the gas generant is in the form of a pellet having a size of about 8.0 mm in diameter by about 2.0 mm in length.
